(19) United States
(12) Patent Application Publication
(10) Pub. No.: US 2007/0231437 A1
(43) Pub. Date: Oct. 4, 2007

(54) Dry milling process for the production of ethanol and feed with highly digestible protein

(75) Inventor: Christopher D. Knight, St. Louis, MO (US)

Correspondence Address: Polsinelli Shalton Welte Suelthaus PC, Suite 1100, 100S. Fourth Street, St. Louis, MO, 63102, US

(73) Assignee: Novus International, Inc.

(21) Appl. No.: 11/393,997

(22) Filed: Mar. 30, 2006

(51) Int. Cl. A23P 1/00

(52) U.S. Cl. 426/518; 426/630

(57) ABSTRACT

The present invention generally relates to a non-heat treated high amino acid feed and to the dry milling process used to produce the feed and ethanol. In particular, the invention relates to a high amino acid feed having highly digestible proteins including amino acid residues substantially free of thermal input related damage.

### FIELD OF THE INVENTION

The present invention generally relates to a dry milling process used to produce ethanol and a feed. More specifically, the invention relates to a high amino acid feed having highly digestible proteins including amino acid residues substantially free of thermal input related damage.

### BACKGROUND OF THE INVENTION

There are two conventional processes for converting starch-containing seeds from grain into ethanol and its feed co-products: a dry milling process and a wet milling process. In a wet milling process, dried corn kernels, for example, are inspected and cleaned to remove the cobs, chaff and other debris. The corn kernels are then soaked in large tanks with small amounts of sulfur dioxide and lactic acid. These two chemicals, in water held at about 50° C., help to soften the corn kernel over a 24 to 48 hour steeping period. During this time, the corn swells and softens and the mild acid conditions loosen the gluten bonds to release the starch. After steeping, the corn is coarsely ground. The ground corn and some steep water are passed through a separator, which essentially allows the germ, or the lightweight oil-containing portion, to float to the top of the mixture to be removed. The fibrous material is screened off, and the starch and gluten are separated by density using large centrifuges. The germ is generally processed by a combination of mechanical and solvent processes to extract the oil from the germ. The oil is then refined and filtered into finished corn oil. The fiber in the fibrous material and the gluten are processed into animal feed. The starch, which typically has just one or two percent protein remaining, may be dried and marketed as corn starch, converted into corn syrups and dextrose, and/or fermented into ethanol. While the wet milling process is an effective means for producing ethanol and feed byproducts, the process suffers from significant drawbacks, including being relatively cost prohibitive and time consuming as compared to a traditional dry milling process.

In contrast, the dry milling process is generally viewed as more cost effective compared to the wet milling process because the dry milling process utilizes the whole corn kernel to produce ethanol instead of first separating the corn kernel into germ, fiber, starch, and gluten fractions. In the dry milling process, the starch within the corn kernel is converted to ethanol and the remaining corn residue is typically used to produce an animal feed, such as distiller's dried grains and distiller's dried grain with solubles. Because the fractions comprising the corn kernel are not separated during the conventional dry milling process, the entire kernel is subjected to heat treatment. The heat treatment, disadvantageously, typically diminishes the protein value of the resulting animal feed. For example, as the proteins contained within the kernel (which later are a portion of the feed) are heated, the epsilon amino group of free lysine and protein-bound lysine (as well as other amino acids) may react with reducing sugars in a Maillard reaction. This reaction generates structurally altered amino acids, such as lysine derivatives called Amadori compounds, deoxy-ketosyl derivatives, or blocked lysine. The Amadori compounds are resistant to gastrointestinal enzymatic breakdown by animals, such as monogastrics, and as such, the feed has a reduced ileal digestibility.

A cost effective, efficient dry milling process that produces a germ enriched feed having highly digestible proteins comprising amino acid residues substantially free of thermal input related damage remains an unmet need.

### SUMMARY OF THE INVENTION

Among the several aspects of the invention are provided dry milling processes to produce ethanol and a feed having highly digestible proteins. Typically, the process comprises separating a seed into a germ fraction and an endosperm fraction at approximately ambient temperature. The process further includes processing the endosperm fraction to form ethanol and processing the germ fraction to produce a feed.

Still further is provided a high amino acid feed. The feed has highly digestible proteins comprising amino acid residues substantially free of thermal input related damage.

Other aspects and features of this invention will be in part apparent and in part pointed out hereinafter.

### BRIEF DESCRIPTION OF THE FIGURES

FIG. 1 is a schematic illustrating a flowsheet of the dry milling process of the invention.

### DETAILED DESCRIPTION OF THE PREFERRED EMBODIMENTS

A cost effective, efficient dry milling process that produces both ethanol and feed having highly digestible protein has been discovered. In the process of the invention, the seed is separated into a germ fraction and an endosperm fraction prior to heat treatment. The endosperm fraction is further processed to produce ethanol and the germ fraction is further processed to produce an animal feed. Because the germ fraction is processed in the absence of heat, the resulting feed has protein, including lysine, that is substantially free of thermal input related damage. The feed produced by the process of the invention may be formulated into a variety of animal diets, such as a high protein diet, a high energy diet, or combinations of both. Advantageously, because the protein in the feed of the invention is typically more highly digestible compared to feed resulting from conventional dry milling processes, less of it has to be fed to the animal in order to achieve similar levels of total digestible protein or similar levels of digestibility for a particular amino acid, such as lysine.

I. Dry Milling Process

One aspect of the invention encompasses a dry milling process that produces ethanol and a feed. In the process, a seed is separated into a germ fraction and endosperm fraction in the absence of heat. The endosperm fraction is used to make ethanol and the germ fraction is used to make a feed. Both processes are described more thoroughly below.

A variety of plants are suitable sources for obtaining seeds that may be utilized in the present invention. Typically, the seed will contain starch (i.e., largely present in the endosperm) and protein (i.e., largely present in the germ). Suitable non limiting examples of plants from which the seeds may be obtained include corn, wheat, barley, sorghum, oats, and rye. In one embodiment, the seed may be from a natural hybrid variety of a plant. Alternatively, the seed may be from an inbred variety of a plant. In another embodiment, the seed may be from a genetically modified variety of a plant. An example of a genetically modified plant is a plant that is a genetically modified high protein plant. In one alternative embodiment, the genetically modified high protein plant may be a plant having a high percentage of a particular amino acid residue (i.e., compared to a non genetically modified plant). The plant in this embodiment, for example, may contain high levels of lysine, methionine, tryptophan, threonine, or cysteine. In an exemplary embodiment, the seed is from a genetically modified corn variety that has high levels of lysine.

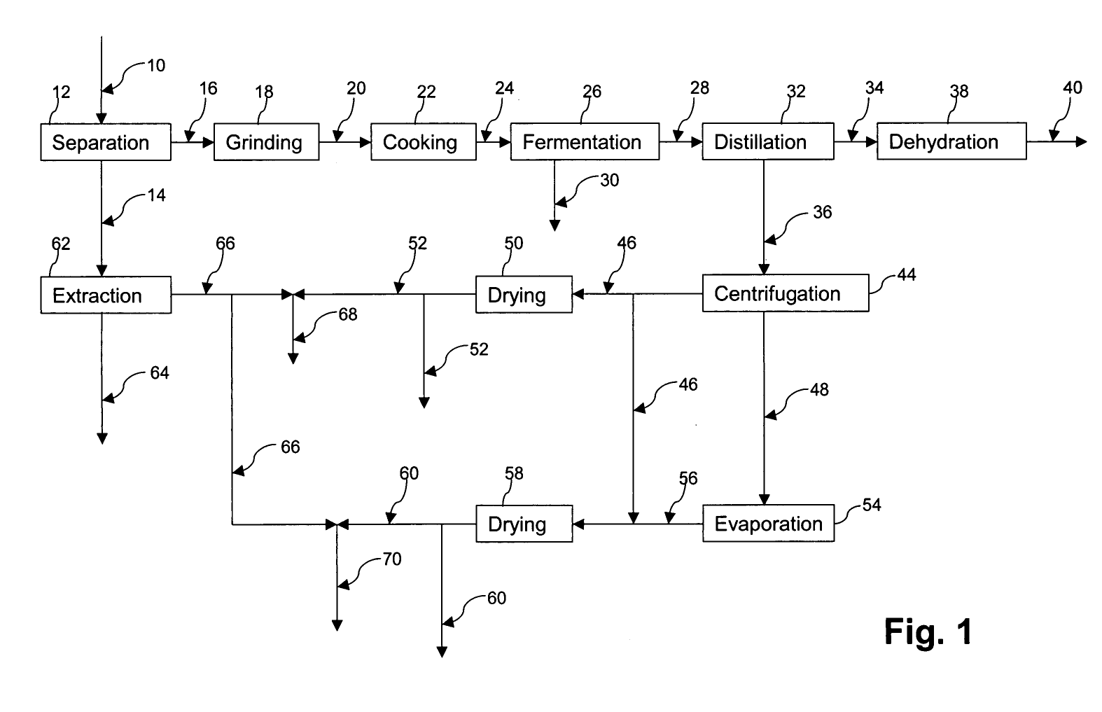

For purpose of illustration, certain embodiments of the present invention will be described with reference to FIG. 1. FIG. 1 depicts a dry milling process for producing ethanol and a feed. The dry milling process may be conducted in a batch, semi-continuous, or continuous mode and it may be carried out using a variety of apparatus and process techniques. As will be appreciated by a skilled artisan, some of the process steps depicted in FIG. 1 may be omitted or combined with other process steps without departing from the scope or spirit of the present invention.

In the process of the invention, a seed 10, obtained from a suitable source, is separated into a germ fraction 14 and an endosperm fraction 16 by a mechanical process 12. The separation process is performed at ambient conditions. In one embodiment, the seed is separated into a germ fraction and an endosperm fraction at a temperature ranging from about 4° C. to about 30° C. In another embodiment, the seed is separated at a temperature ranging from about 10° C. to about 25° C. Separating the germ and endosperm fractions may be done by any method known in the art that can separate at ambient temperatures. In an exemplary embodiment, the separation is performed by a mechanical means. Various mechanical separation processes generally known in the art may be used in the invention. In one embodiment, a gradual reduction process may be used to separate the seed into fractions. A gradual reduction process includes successive differential grinding and sifting to separate the basic components of a seed, i.e. the endosperm, and germ. This process may also include tempering the seed to facilitate the separation of the basic components of the seed during the grinding process. In another embodiment, a degermination process may be used to separate the seed into fractions, as disclosed in U.S. Pat. No. 5,250,313, which is hereby incorporated by reference in its entirety. After the separation of the seed into fractions, the endosperm fraction is utilized to produce ethanol and the germ fraction is utilized to produce feed.

(a) Production of Ethanol from the Endosperm Fraction

The separated endosperm fraction 16 of the seed is further processed to produce ethanol 40 in the present invention. The endosperm fraction 16 is first subjected to a grinding operation 18 to grind the endosperm fraction 16 to the consistency of coarse flour. The grinding process substantially destroys the integrity of the endosperm, thereby allowing water to directly contact the inner starch molecules of the endosperm. In addition, the small particles produced by the mills facilitate rapid penetration of water throughout the starch by significantly increasing the surface area to volume ratio of the seed. The grinding operation may be carried by any method generally known in the art. Suitable grinding apparatus include a hammer mill or a roller mill.

The ground endosperm 20 is then subjected to a cooking operation 22 to prepare the starch molecules of the endosperm for fermentation and produce a sugar molecule mixture 24. The cooking operation 22 includes mixing the ground endosperm with water at a temperature above approximately 100° C. and a pressure of 10 to 40 psig and holding the mixture at temperatures of from about 80° C. to about 95° C. for from about 4 to about 8 hours. During this process two enzymes are also added to the mixture. The first enzyme, alpha amylase, chemically breaks the starch molecules into short dextrin sections in a process called liquefaction. The second enzyme, glucoamylase, chemically breaks the short dextrin sections into individual sugar molecules, or glucose molecules, in a process called saccharification.

The mixture containing the sugar molecules 24 is next subjected to a fermentation operation 26 to produce an ethanol product 28 and carbon dioxide 30. The fermentation operation 26 generally comprises adding large amounts of yeast to the sugar molecule containing mixture in fermentation tanks. The yeast is used to convert the simple sugar molecules into ethanol. The fermentation time may vary considerably based on a variety of factors such as the particular yeast strain employed, rate of enzyme addition, temperature at which fermentation is conducted, and final targeted ethanol concentration.

The ethanol product 28 from the fermentation operation 26 is then subjected to a distillation operation 32 to separate the ethanol 34 from the non-fermentable components 36. Generally the distillation operation 32 comprises feeding the ethanol product 28 through a distillation column to boil off the ethanol 34 and separate the ethanol 34 from the non-fermentable components 36. Typically, because the distilled ethanol 34 still includes approximately 5% water, it is further subjected to a dehydration operation 38 to separate the purified ethanol 40 from the water. The dehydration operation 38 may, for example, be performed in an azeotropic distillation or a drying column packed with molecular sieves.

Although the endosperm fraction may be subjected to a dry milling process that includes a cooking operation as described above, alternatively, the endosperm fraction may be subjected to a dry milling process that converts starch to ethanol, while maintaining a temperature below the starch gelatinization temperature, as disclosed in U.S. Patent Application No. 2004/0234649, which is herein incorporated by reference in its entirety, without departing from the scope of the invention.

The non-fermentable components 36, of either process, include both liquid and solid materials. A centrifugation operation 44 separates the non-fermentable components 36 into solids, known as wet cake 46, and liquids, known as thin stillage 48. The wet cake 46 generally includes unfermented grain solids and spent yeast solids. The wet cake 46 may be further dried 50 to produce distiller's dried grain 52. The thin stillage 48 may be concentrated by an evaporation operation 54 to a syrup 56, which may optionally be added to the wet cake 46 and the mixture then dried 58 to form distiller's dried grain with solubles 60. The wet cake 46 may be dried 50 (or 58) by any conventional drying method including drum dryers, flash dryers, or ring dryers.

(b) Production of Feed from the Germ Fraction

After the germ fraction 14 is separated from the seed 10 it is subjected to an extraction operation 62 to produce a seed oil 64 and a feed 66. Seed oil 64 may be extracted from the seed by various extraction steps using any generally known extraction method. Preferably, the extraction operation 62 is performed mechanically at ambient temperatures. Suitable extraction methods include hydraulic pressing and expeller pressing. The extraction operation 62 produces a seed oil 64 and a non-heat treated germ fraction, or feed 66. Typically, a diet, such as a monogastric diet, may contain from about 0.1% to about 10% by weight of the high amino acid enriched feed of the invention.

Alternatively, the non-heat treated feed 66 may be combined with at least a portion of distiller's dried grain 52 to form a distiller's dried grain feed 68. In another embodiment, the feed 66 may be combined with at least a portion of distiller's dried grain with solubles 60 to form a distiller's dried grain with solubles feed 70.

(c) Genetically Modified High Lysine Corn Varieties

In an exemplary embodiment, the seed used in the dry milling process of the invention is from a genetically modified high lysine variety of corn. High-lysine corn generally contains increased levels of glutelin, and the protein fraction is rich in lysine and tryptophan. A single recessive gene, Opaque-2, controls this protein alteration. Kernels formed from the Opaque-2 gene generally have a softer endosperm making high-lysine corn more palatable and significantly more digestible than normal corn. Genetically modified high lysine corn can, for example, be purchased from Renessen under the name Mavera® High Value Corn with Lysine. High lysine corn has approximately 50% higher lysine content than conventional corn. Generally, conventional corn has about 0.26% by weight lysine. Genetically modified high lysine corn has about 0.4% or more by weight lysine.

In the process of the invention, the genetically modified high lysine corn is separated into a high lysine germ fraction and an endosperm fraction at approximately ambient temperature. The endosperm fraction is further processed to produce ethanol, according to the process described in (a) above.

The high lysine germ fraction is then further processed to produce a feed having highly digestible lysine in accordance with the process described more fully in (b) above. Briefly, the high lysine germ fraction is subjected to an extraction operation to produce a seed oil and a high lysine feed. In one embodiment, the high lysine feed is combined with the distiller's dried grain produced in the ethanol process to form a distiller's dried grain feed having highly digestible lysine. In another embodiment, the high lysine feed is combined with the distiller's dried grain with solubles produced in the ethanol process to form a distiller's dried grain with solubles feed having highly digestible lysine.

As will be appreciated by a skilled artisan, any genetically modified high protein seed may be used to produce ethanol and feed in accordance with the dry milling process of the present invention. For example, plant varieties having a high content of amino acids selected from the group consisting of lysine, methionine, tryptophan, threonine, and cysteine all may be utilized in the invention.

II. High Amino Acid Feed

Another aspect of the invention provides a non-heat treated high amino acid feed having highly digestible proteins. Because the germ fraction is processed in the absence of heat, as detailed above, the resulting feed typically comprises amino acid residues substantially free of heat related damage and more precisely, substantially free of thermal input related damage. In this context, “thermal input related” damage refers to both the temperature and heating time to which the protein is subjected. As will be appreciated by a skilled artisan, proteins present in a feed can and will undergo a variety of thermal input related damage. The process of the present invention, however, provides a feed having amino acids that are highly bioavailable because the feed has not been subjected to thermal input. A bioavailable amino acid is one that can be absorbed in a chemical form that is suitable for in vivo protein synthesis. In an exemplary embodiment, when the feed is fed to a monogastric, the amino acids will typically have a high ileal digestibility.

As utilized herein, phrases such as “highly bioavailable” or “highly digestible” are used in a comparative sense-comparing the value of bioavailability or digestibility of the protein present in the feed of the invention with protein present in a feed subjected to significant thermal input. The phrases “bioavailable” or “digestible” may refer to either the total protein present in the feed, including all of the amino acids comprising the protein, or it may refer to a specific amino acid. By way of non limiting example, the feed of the present invention may have total protein that is from about 1% to about 99% more bioavailable or ileal digestible compared to a feed subjected to significant thermal input. By way of further example, the feed of the present invention may have total protein that is from about 1% to about 50%, or from about 5% to about 25%, or from about 5% to 10% more bioavailable or ileal digestible compared to a feed subjected to significant thermal input. A variety of method known in the art are suitable for determining the bioavailability of a protein or of an amino acid comprising a protein, including for example, slope ratio techniques in which the response of an animal to increased intake of an amino acid is measured. Ileal digestibility of a particular amino acid may be determined according to methods generally known in the art, such as detailed in Sauer and Lange ((1992) Novel Methods for Determining protein and amino acid digestibilities in feedstuffs. P. 87-120 in Nissen, S. (Ed.): Modern methods in protein nutrition and metabolism. Academic Press, Inc., San Diego, Calif.), which is hereby incorporated by reference in its entirety.

In one exemplary embodiment, the feed of the present invention is comprised of individual amino acid residues that are more highly digestible because they have not undergone a Maillard reaction. In a Maillard reaction, one or more nucleophilic α-amino group of an amino acid, such as asparagine or lysine, reacts with a carbonyl carbon of the reducing sugar, forming early and late Maillard products. In the case of lysine, the early Maillard products are structurally altered lysine derivatives that are called Amadori compounds, deoxy-ketosyl derivatives, or blocked lysine, while the late Maillard products are called melanoidins. The collective impact of Amadori compounds and melanoidins, is a feed that has either a lower concentration of lysine, a lower concentration of digestible lysine, or a combination of both.

The feed of the present invention is substantially free of Maillard products. In one embodiment, the feed of the present invention is at least 75% free of Maillard products. In another embodiment, the feed of the present invention is from about 80% to about 99% free of Maillard products. In still another embodiment, the feed of the present invention is from about 90% to 99% free of Maillard products. In another embodiment, the feed of the present invention is at least 95% free of Maillard products. In yet another embodiment, the feed of the invention is at least 97% free of Maillard products. In another embodiment, the feed of the invention is at least 99% free of Maillard products. Any method generally known to a skilled artisan may be utilized to determine the amount of Maillard products present a feed.

The non-heat treated high amino acid feed may be fed to an animal in a variety of suitable formulations, as detailed below. Because the protein in the non-heat treated high amino acid feed is typically more highly digestible and/or bioavailable compared to distiller's dried grain with solubles feed resulting from conventional dry milling processes, less of it has to be fed to an animal in order to achieve similar levels of total digestible protein or similar levels of digestibility of a particular amino acid, such as lysine.

III. Animal Feed Diets

A further aspect of the invention comprises a feed diet comprising the non-heat treated high amino acid feed of the invention. The feed diet may be formulated to meet the nutritional requirements of a desired animal. The animal may be a monogastric. Monogastrics include poultry, swine, horses, fish, dogs, and cats. Typically, a diet, such as a monogastric diet, may contain from about 0.1% to about 10% by weight of the high amino acid enriched feed of the invention. In one embodiment, the diet contains from about 1% to about 5% by weight of the high amino acid enriched feed of the invention. In another embodiment, the diet contains from about 1% to about 3% by weight of the high amino acid enriched feed of the invention. Those of skill in the art can readily formulate a feed diet to meet the nutrient needs of a particular animal species.

In one embodiment, the feed diet may include one or more grain sources, one or more protein sources of vegetable or animal origin, one or more of a mixture of natural amino acids, analogs of natural amino acids, such as a hydroxyl analog of methionine (“HMTBA”), vitamins and derivatives thereof, enzymes, animal drugs, hormones, effective microorganisms, organic acids, preservatives, flavors, and inert fats.

In another embodiment, the feed will include one or more amino acids. Suitable examples of amino acids, depending upon the formulation, include alanine, arginine, asparagines, aspartate, cysteine, glutamate, glutamine, glycine, histidine, isoleucine, leucine, lysine, methionine, phenylalanine, proline, serine, threonine, tryptophan, tyrosine, and valine. Other amino acids usable as feed additives include, by way of non-limiting example, N-acylamino acids, hydroxy homologue compounds, and physiologically acceptable salts thereof, such as hydrochlorides, hydrosulfates, ammonium salts, potassium salts, calcium salts, magnesium salts and sodium salts of amino acids.

In one exemplary embodiment, the feed will include a hydroxy analog of methionine (“HMTBA”). Suitable hydroxyl analogs of methionine include 2-hydroxy-4(methylthio)butanoic acid (sold by Novus International, St. Louis, Mo. under the trade name Alimet®), its salts, esters, amides, and oligomers. Representative salts of HMTBA include the ammonium salt, the stoichiometric and hyperstoichiometric alkaline earth metal salts (e.g., magnesium and calcium), the stoichiometric and hyperstoichiometric alkali metal salts (e.g., lithium, sodium, and potassium), and the stoichiometric and hyperstoichiometric zinc salt. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

In still another embodiment, the feed will include vitamins or derivatives of vitamins. Examples of suitable vitamins and derivatives thereof include vitamin A, vitamin A palmitate, vitamin A acetate, β-carotene, vitamin D (e.g., D2, D3, and D4), vitamin E, menadione sodium bisulfite, vitamin B (e.g., thiamin, thiamin hydrochloride, riboflavin, nicotinic acid, nicotinic amide, calcium pantothenate, pantothenate choline, pyridoxine hydrochloride, cyanocobalamin, biotin, folic acid, p-aminobenzoic acid), vitamin K, vitamin Q, vitamin F, and vitamin C.

In yet another embodiment, the feed will include one or more enzymes. Suitable examples of enzymes include protease, amylase, lipase, cellulase, xylanase, pectinase, phytase, hemicellulase and other physiologically effective enzymes.

In still another embodiment, the feed will include a drug approved for use in animals. Non-limiting examples of suitable animal drugs include antibiotics such as tetracycline type (e.g., chlortetracycline and oxytetracycline), amino sugar type, ionophores (e.g., rumensin, virginiamycin, and bambermycin) and macrolide type antibiotics.

In an additional embodiment, the feed will include a hormone. Suitable hormones include estrogen, stilbestrol, hexestrol, tyroprotein, glucocorticoids, insulin, glucagon, gastrin, calcitonin, somatotropin, and goitradien.

In a further embodiment, the feed will include an effective microorganism. Examples of suitable effective microorganisms include live and dead yeast cultures, which may be formulated as a probiotic. By way of example, such yeast cultures may include one or more of Lactobacillus Acidophilus, Bifedobact Thermophilum, Bifedobat Longhum, Streptococcus Faecium, Sacchromyces cerevisiae, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacteriium freudenreichii, Aspergillus oryzae, and Bifidobacterium Pscudolongum.

In yet another embodiment, the feed will include an organic acid. Suitable organic acids include malic acid, propionic acid and fumaric acid.

In still another embodiment, the feed will include a preservative. Examples of preservatives include natural and synthetic antioxidants. By way of example, natural antioxidants include vitamins E and C. Synthetic antioxidants include ethoxyquin, butylated hydroxytoluene, and butylated hydroxyanisol. In a preferred embodiment, the antioxidant is ethoxyquin.

In an additional embodiment, the feed will include a substance to increase the palatability of the feed diet. Suitable examples of such substances include natural sweeteners, such as molasses, and artificial sweeteners such as saccharin and aspartame.

As will be appreciated by the skilled artisan any of the substance that may be included in the feed diet of the invention can be used alone or in combination with one another. The concentration of these additives will depend upon the application but, in general, will be between about 0.0001% and about 10% by weight of the dry matter, more preferably between about 0.001% and about 7.5%, most preferably between about 0.01% and about 5%.

What is claimed is:

1. A dry milling process, the process comprising:
a. separating a seed into a germ fraction and an endosperm fraction at approximately ambient temperature;
b. processing the endosperm fraction to form ethanol; and
c. processing the germ fraction at ambient temperatures to produce a feed, the feed having highly digestible proteins comprising amino acid residues substantially free of thermal input related damage.

2. The process of claim 1, wherein the separation is performed by a mechanical process.

3. The process of claim 1, wherein the separation is performed at a temperature ranging from about 4° C. to about 30° C.

4. The process of claim 1, further producing a seed oil.

5. The process of claim 1, wherein the feed further comprises distiller's dried grain.

6. The process of claim 1, wherein the feed further comprises distiller's dried grain with solubles.

7. The process of claim 1, wherein the seed is from a plant selected from the group consisting of corn, wheat, barley, sorghum, oats, and rye.

8. The process of claim 1, wherein the seed is from corn.

9. The process of claim 8, wherein the corn is from a genetically modified high protein corn variety.

10. The process of claim 9, wherein genetically modified high protein corn comprises seeds having high levels of an amino acid residue selected from the group consisting of lysine, methionine, tryptophan, threonine, and cysteine.

11. The process of claim 9, wherein the genetically modified corn is from a high lysine variety.

12. The process of claim 11, wherein the genetically modified corn has greater than about 0.4% lysine by weight.

13. The process of claim 11, wherein the lysine present in the feed has a high ileal digestibility level.

14. The process of claim 13, wherein the lysine present in the germ faction does not undergo a Maillard reaction.

15. The process of claim 1, wherein the protein present in the feed has a high ileal digestibility level.

16. A feed produced by the process of claim 1.

17. The feed of claim 16, further comprising a hydroxyl analog of methionine.

18. The feed of claim 16, wherein the hydroxyl analog of methionine is 2-hydroxy-4(methylthio)butanoic acid or a salt, ester, or amide of 2-hydroxy-4(methylthio)butanoic acid.

19. A dry milling process, the process comprising:
a. separating a seed from a genetically modified high lysine corn variety into a germ fraction and an endosperm fraction at approximately ambient temperature;
b. processing the endosperm fraction to form ethanol; and
c. processing the germ fraction to produce a seed oil and a non-heat treated high lysine feed.

20. The process of claim 19, wherein the lysine present in the germ faction does not undergo a Maillard reaction.

21. The process of claim 19, wherein the protein present in the feed has a high ileal digestibility level.

22. A feed produced by the process of claim 19.

23. The feed of claim 22, further comprising a hydroxyl analog of methionine.

24. The feed of claim 22, wherein the hydroxyl analog of methionine is 2-hydroxy-4(methylthio)butanoic acid or a salt, ester, or amide of 2-hydroxy-4(methylthio)butanoic acid.
